(19) United States
(12) Patent Application Publication
(10) Pub. No.: US 2017/0056918 A1
(43) Pub. Date: Mar. 2, 2017

(54) Parallel Motion Method for Depositing a Substance on Articles

(71) Applicant: The Procter & Gamble Company, Cincinnati, OH (US)

(72) Inventors: Matthew Richard Allen, Mason, OH (US); Robert Paul Cassoni, Washington Township, OH (US); Paul Edmund Baker, Silchester (GB)

(21) Appl. No.: 15/243,998

(22) Filed: Aug. 23, 2016

Related U.S. Application Data
(60) Provisional application No. 62/211,999, filed on Aug. 31, 2015.

(51) Int. Cl. B05D 1/02; B41J 3/407

(52) U.S. Cl. CPC B05D 1/02; B41J 3/4073

(57) ABSTRACT

Apparatuses and methods for depositing a substance onto an article are disclosed, including apparatuses and methods of directly printing on and/or decorating three-dimensional articles, as well as the articles printed and/or decorated thereby. The apparatuses include a conveyor having at least a first station and a second station thereon or adjacent thereto. There is a first substance deposition device located at the first station and a second device, such as a functional device, located at the second station. The apparatus and method are such that at least at the first station where the first substance deposition device is located, a cycle of at least two intra-station movements occur between the article and the deposition device. The relative motion between the article and deposition device may be substantially in translation. The substance deposition device may deposit a substance on the article in an array during the intra-station movements to form different portions of a predetermined pattern.

### FIELD OF THE INVENTION

The present invention is directed to apparatuses and methods for depositing a substance onto the surface of an article, including apparatuses and methods of printing directly on and/or decorating three-dimensional articles, as well as the articles printed and/or decorated thereby.

### BACKGROUND

Various apparatuses and methods of printing are disclosed in the patent literature and on the internet. Patent publications disclosing apparatuses and methods of printing include: U.S. Pat. No. 6,135,654, Jennel; U.S. Pat. No. 6,699,352 B2, Sawatsky; U.S. Pat. No. 7,210,408 B2, Uptergrove; U.S. Pat. No. 7,467,847 B2, Baxter, et al.; U.S. Pat. No. 8,522,989 B2, Uptergrove; U.S. Pat. No. 8,579,402 B2, Uptergrove; U.S. Pat. No. 8,667,895 B2, Gerigk, et al.; and US Patent Application Publication Nos. US 2011/0232514 A1, Putzer, et al.; US 2013/0019566 A1, Schach; and US 2014/0285600 A1, Domeier, et al.; and French Patent 3001915. Other types of apparatuses and methods include the apparatus and method disclosed in U.S. Patent Application Pub No. US 2012/0031548 A1, “Apparatus and Method for Applying a Label to a Non-Ruled Surface”, filed in the name of Broad.

A number of current efforts are being directed to printing, particularly inkjet printing, on three-dimensional articles such as bottles and the like. Current printing apparatuses may either be of the single pass or the multi-pass type. Single pass apparatuses have the advantage that they are faster than multi-pass apparatuses. Multi-pass apparatuses can achieve better quality, but since the print heads must pass over the article multiple times in an indexing fashion, they are slower than single pass apparatuses. Unfortunately, with current inkjet technology and current printing apparatuses, the quality of printing such as labels that can be formed by printing directly on three-dimensional articles is not as good as that formed on separately printed flat labels. Most of the efforts appear to be directed to attempting to improve the quality of single pass apparatuses. A need exists for improved apparatuses and methods of printing, particularly for printing on three-dimensional articles.

### SUMMARY

The present invention is directed to apparatuses and methods for depositing a substance onto the surface of an article, including apparatuses and methods of printing directly on and/or decorating three-dimensional articles, as well as the articles printed and/or decorated thereby.

The apparatus comprises a conveyor for transporting articles in a conveying direction. The conveyor comprises at least two stations thereon or adjacent thereto which comprise a first station and a second station. The apparatus may further comprise at least one substance deposition device. A first substance deposition device is located at the first station and a second device, such as a functional device, is located at the second station for performing a function on the articles. The substance deposition device may operate such that at least at the first station where the first substance deposition device is located, a cycle of at least two intra-station movements are used to deposit a substance on an article.

The apparatus may further comprise optional functional devices at one or more additional stations for performing a function on the articles. The functional devices may include, but are not limited to: additional substance deposition devices; devices for treating articles (e.g., devices for treating the surface of articles, or for curing substances applied to the articles); devices for decorating articles (e.g., application of a metal foil); devices for transforming a property of an article (e.g., laser); or combinations thereof.

In some cases, the method comprises a process for depositing a substance onto an article in a predetermined pattern which comprises:
a) providing an apparatus such as that described above;
b) providing at least one three-dimensional article which has a surface;
c) conveying the article in the conveying direction with the conveyor so that the article is adjacent to the first substance deposition device at the first station with the surface of the article facing the first substance deposition device;
d) while at the first station, moving the article and/or the first substance deposition device in a first of at least two intra-station movements wherein the first substance deposition device deposits a first substance on the surface of the article so that the first substance is deposited in a first array to form only a portion of the predetermined pattern; and
e) while still at the first station, moving the article and/or the first substance deposition device in a second of at least two intra-station movements wherein the first substance deposition device deposits a second application of a substance on the surface of the article within the first array to form another portion of the predetermined pattern,

wherein the steps of moving the article and/or deposition device in steps d) and e) is such that the primary relative motion between the article and deposition device is substantially in translation.

In some cases, the relative motion between articles and deposition device can be solely in translation. In such cases, there will be no rotational movement of the articles about their own axis relative to the deposition device. However, other types of relative motion are also possible. For example, in certain embodiments, it may be desired to move the article in order to present a different portion of the article to the deposition device. In some cases, a rotational component (or secondary motion) can be added to the movement by translation (the primary movement during substance deposition). However, any rotation of the articles about an article's own axis should be less than 360°

### BRIEF DESCRIPTION OF THE DRAWINGS

FIG. 1 is a perspective view of one embodiment of an apparatus for depositing a substance onto the surface of an article.

FIG. 1A is a schematic front view of one of the stations of the apparatus shown in FIG. 1 showing the first of two intra-station movements of the print head.

FIG. 1B is a schematic front view of the station of the apparatus shown in FIG. 1A showing an optional offset/shift between intra-station movements.

FIG. 1C is a schematic front view of the station of the apparatus shown in FIG. 1A showing the print head during the second of two intra-station movements of the print head.

FIG. 2A is a schematic front view of one of the stations of the apparatus shown in FIG. 1 showing another embodiment of the first of two intra-station movements of the print head.

FIG. 2B is a schematic front view of the station of the apparatus shown in FIG. 2A showing an optional reset motion between intra-station movements.

FIG. 2C is a schematic front view of the station of the apparatus shown in FIG. 2A showing an optional offset/shift between intra-station movements.

FIG. 2D is a schematic front view of the station of the apparatus shown in FIG. 2A showing the print head during the second of two intra-station movements.

FIG. 3A is a schematic front view of one of the stations of the apparatus shown in FIG. 1 showing another embodiment of the first of two intra-station movements in which the holder is moved with the articles therein.

FIG. 3B is a schematic front view of the station of the apparatus shown in FIG. 3A showing an optional offset/shift of the holder between intra-station movements.

FIG. 3C is a schematic front view of the station of the apparatus shown in FIG. 3A showing the second of two intra-station movements of the holder.

FIG. 4A is a schematic front view of one of the stations of the apparatus shown in FIG. 1 showing the first of two intra-station movements in which the holder is moved with the articles therein.

FIG. 4B is a schematic front view of the station of the apparatus shown in FIG. 4A showing an optional reset motion of the holder between intra-station movements.

FIG. 4C is a schematic front view of the station of the apparatus shown in FIG. 4A showing an optional offset/shift of the holder between intra-station movements.

FIG. 4D is a schematic front view of the station of the apparatus shown in FIG. 4A showing the second of two intra-station movements of the holder.

FIG. 5 is a schematic side view of another embodiment of an apparatus for depositing a substance onto an article.

FIG. 6 is a schematic side view of another embodiment of an apparatus for depositing a substance onto an article.

FIG. 7 is a schematic front view of a print head showing one example of an arrangement of nozzles thereon.

FIG. 8A is a schematic front view of one example of a two-dimensional representation of an array of pixels that form only a portion of the total predetermined pattern to be printed on the surface of an article in a two-step printing process.

FIG. 8B is a schematic front view of a two-dimensional representation of an array of pixels that form the total predetermined pattern to be printed on the surface of an article in a two-step printing process.

FIG. 8C is a schematic front view of one example of a two-dimensional representation of an array of pixels that form a first portion of the total predetermined pattern to be printed on the surface of an article in a four-step printing process.

FIG. 8D is a schematic front view of one example of a two-dimensional representation of an array of pixels that form the first and second portions of the total predetermined pattern to be printed on the surface of an article in a four-step printing process.

FIG. 8E is a schematic front view of one example of a two-dimensional representation of an array of pixels that form the first, second, and third portions of the total predetermined pattern to be printed on the surface of an article in a four-step printing process.

FIG. 8F is a schematic front view of a two-dimensional representation of an array of pixels that form the total predetermined pattern to be printed on the surface of an article in a four-step printing process.

FIG. 9 is a schematic view looking at the side of an article and a print head showing the translational movement between the article and print head.

FIG. 10A is a schematic side view of one embodiment of a station for carrying out the steps of applying a metallic foil to an article.

FIG. 10B is a schematic side view of an alternative embodiment of a station for carrying out the steps of applying a metallic foil to an article.

The embodiments of the method, apparatus(es), and articles shown in the drawings are illustrative in nature and are not intended to be limiting of the invention defined by the claims. Moreover, the features of the invention will be more fully apparent and understood in view of the detailed description.

### DETAILED DESCRIPTION

The present invention is directed to apparatuses and methods for depositing a substance onto the surface of an article, including apparatuses and methods of printing directly on and/or decorating three-dimensional articles, as well as the articles printed and/or decorated thereby.

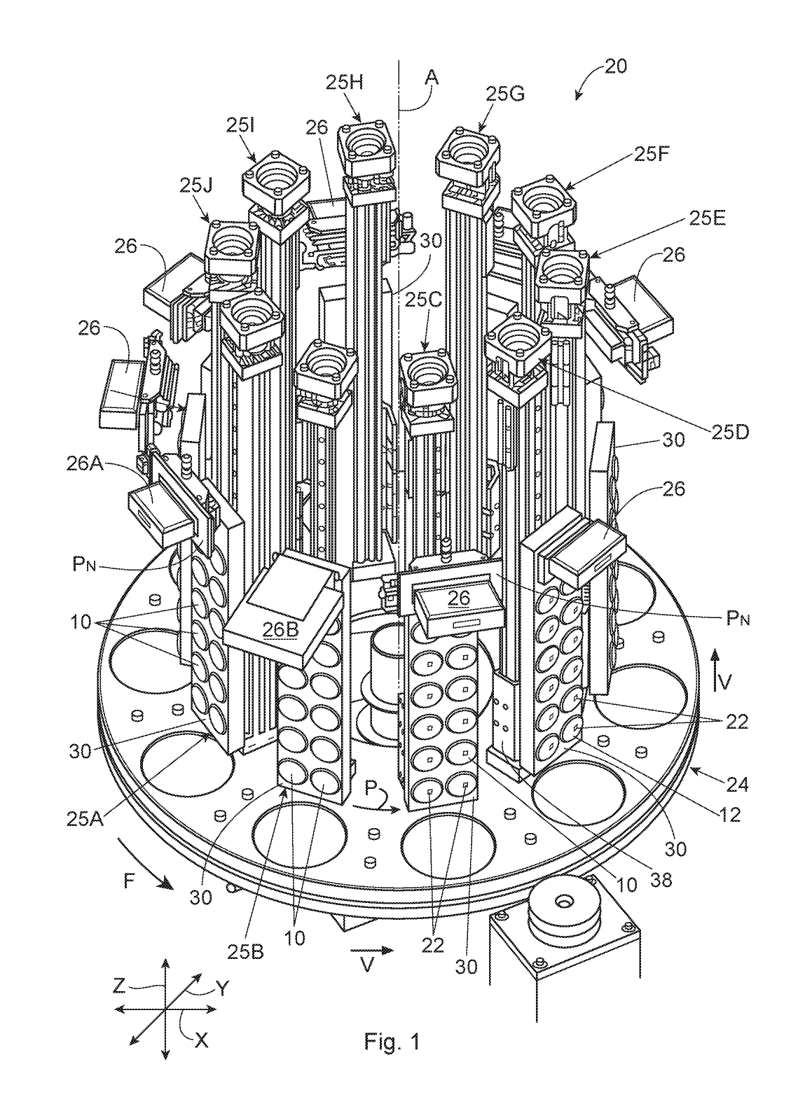

FIG. 1 shows one non-limiting embodiment of an apparatus 20 for depositing a substance 22 onto the surface of at least one article 10. As shown in FIG. 1, the apparatus 20 comprises an article conveyor 24 that conveys at least one article 10 to at least two stations designated generally 25. There can be any suitable number of stations 25 along the conveyor 24, such as from 2 to 20, or more. The at least two stations are associated with a single conveyor 24. The stations 25 are each used for performing a function on the article(s). The stations 25 can include stations for depositing a substance 22 on the article (with a substance deposition device 26), a station for decorating the article, and/or stations for performing other functions on the article. The individual stations can be designated 25A, 25B, 25C, etc.

The apparatus 20 may comprise at least one substance deposition device 26. The substance deposition device comprises a first substance deposition device 26A located at the first station 25A. A second device, such as a functional device which may (or may not) be a deposition device 26B may be located at the second station 25B. The designation of one station as a “first” station and one as a “second” station is intended only to mean that there is one station (a first station) and there is another station (a second station). These designations are not meant to imply that the first station is the location of the very first operation performed on the articles and that the second station is the location of the second operation performed on the articles. These designations are not meant to imply that the operation at the second station has to take place in sequence after the operation at the first station. The operations performed at the first and second stations can take place in any order. The operation at the first station can occur before the operation at the second station; or, the operation at the second station can occur before the operation at the first station. Nor do these designations imply that there cannot be any stations in between the first and second stations. Thus, the first and second stations may, or may not be adjacent to each other. The substance deposition devices are such that at least at the first station 25A where the first substance deposition device 26A is located, a cycle of at least two intra-station movements are used to deposit a substance on an article 10.

The apparatus 20 can be used to perform functions on numerous different types of three-dimensional articles 10. Such articles include, but are not limited to: bottles; boxes; cans; cartons; containers; laundry dosing balls; razors; components of consumer products such as razor blade heads and handles; sprayer triggers; tubs; tubes including, but not limited to tampon tubes; and deodorant stick containers. The articles may include primary packages for consumer products, including disposable consumer products. Additional articles include components of containers or packages including, but are not limited to: bottle caps, closures, and bottle pre-forms that are subsequently blown into the form of a finished bottle. The apparatus 20 can be used to convey and print empty containers, partially filled, or full containers. The containers can have a rigid or flexible structure in whole or in part. Such containers may be capped or uncapped. The articles can be made of any suitable material, including but not limited to: plastic, metal, and/or cardboard.

The articles 10, if three-dimensional, will typically have at least two opposing ends. For example, a bottle will have a base and a top. The articles 10 may also have a front, a back, and sides. The articles 10 will also have a surface 12. The articles 10 may be solid as in the case of some razor blade handles, or hollow in the case of bottles, for example. If the articles are hollow, they will also have an interior. The surface of the articles 10 may be flat or curved. The entire surface need not be either flat or curved. For example, the surface of the articles 10 may have: portions that are flat; portions that are curved; or, the surface may have both flat portions and curved portions. For instance, in the case of bottles, at least a portion of the surface may have a convex curvature. It is also possible that some articles may have a surface in which a portion thereof has a concave curvature.

The term “conveyor”, as used herein, refers to devices that move articles generally, and is not limited to conveyor belts. The conveyor 24 can be any suitable type of device for conveying the article(s) 10 past the deposition device(s) 26 and any functional devices. Suitable conveyors include, but are not limited to: turret conveyors including turning rotary turrets, star wheel conveyors including turning and rotary wheels, endless loop conveyors which may be in the form of tracks, belts, chains, and the like.

The conveyor 24 can hold any suitable number of articles 10 at a given time. Suitable numbers of articles 10 can range from 1-200, or more articles. The article(s) 10 can be placed individually on the conveyor for presentation to a station, or they can be placed in groups of two or more articles on the conveyor for presentation to a single station. The articles or groups of articles on the conveyor at a given time will typically all travel on the same path P, until the articles are removed from the conveyor 24 for subsequent processing. The number of articles 10 on the conveyor 24 at a given time may be less than, equal to, or greater than the number of stations 25 disposed on or adjacent to the conveyor 24.

The article(s) 10 may each be placed on the conveyor 24 at a given site, such as in a depression or a well in the conveyor 24. The articles 10 can be in any suitable orientation on the article conveyor 24. For example, the articles 10 may be situated in an upright orientation, or an upside down orientation on the conveyor 24 (and in any article holders 30). Alternatively, the articles 10 may lay flat on the conveyor 24 (and in any article holders 30). The only requirement is that the portion of the surface 12 of the articles 10 on which the substance 22 is to be deposited should be exposed to the deposition device 26 at the time it is desired to deposit the substance 22 on the article 10.

The article(s) 10 can be held in place on the conveyor 24 in any suitable manner, such as by vacuum. Alternatively, as shown in FIG. 1, the conveyor 24 may comprise at least one optional holder 30 for an article 10, which holder 30 is joined to the conveyor 24. The term “joined to” encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The holder(s) 30 can be either permanently joined to the conveyor 24 or removably joined to the conveyor 24.

The holder 30 may be in any suitable form. Suitable holders include, but are not limited to: brackets, pucks or trays, grips, clamps, suction devices, or fingers. The holder 30 may hold one or more articles. In the embodiment shown in FIG. 1, the holder 30 is in the form of a tray for holding multiple articles. When the holder 30 holds multiple articles, the articles 10 can be in any suitable arrangement, including but not limited to linear arrangements and side-by-side arrangements. In the embodiment shown in FIG. 1, the articles 10 are in a linear arrangement with the articles oriented in a vertical array with each article side-by-side with another article. The articles in a given holder can either be all the same, or they can be different. When it is said that the articles are different, they may differ in any known manner including, but not limited to: type, size, and/or shape. If there is more than one holder 30, the holders may be joined to the conveyor 24 in any suitable arrangement. Suitable arrangements include, but are not limited to a radial array about a circular conveyor 24. The articles in the different holders 30 may also differ in any known manner. In these, or other embodiments, the articles 10 in different holders 30 may be printed or decorated differently, for instance if it is desired to provide customized articles or packaging for the articles.

If the holder 30 is removably joined to the conveyor 24, the holder 30 can be loaded with articles 10 in any suitable manner. For example, the holder 30 can be removed from the conveyor 24 and have at least one article loaded into the holder, and the holder 30 can then be joined to the conveyor. The holder 30 can remain joined to the conveyor 24 until such time as it is desired to remove the holder 30 from the conveyor 24 to send the articles onto a subsequent step and receive a holder with one or more new articles therein.

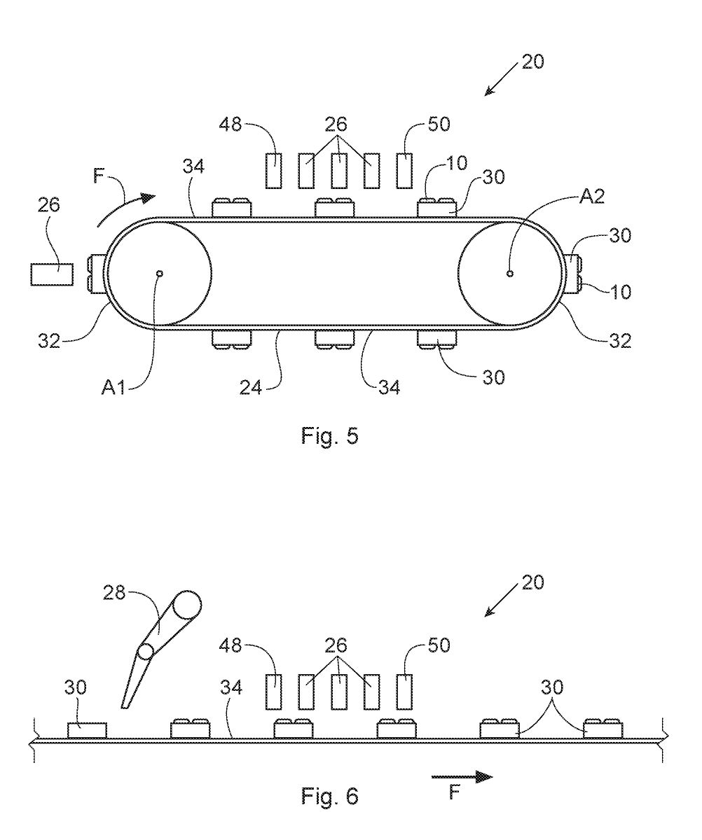

In other embodiments, such as shown in FIG. 6, a mechanical motion device (robot, etc.) 28 can be provided which is adjacent to the apparatus 20. The apparatus 20 and the mechanical motion device 28 in such an embodiment may be considered to comprise a system for: a) loading and unloading articles into the holders and/or onto the conveyor 24, and b) depositing a substance onto the articles 10. The mechanical motion device 28 may be any suitable device that is capable of moving articles. Mechanical motion devices include, but are not limited to: independently actuatable automatic arms, pneumatic arms, robots, and other mechanical moving elements. In some embodiments, the articles 10 can be loaded into the holder 30 and removed from the holder by the mechanical motion device 28. Any suitable number of articles can be loaded into and removed from the holder 30 at a given time. In other embodiments, the holder(s) 30 could already be provided with the articles 10 therein, and the mechanical motion device can load the holders 30 onto the conveyor 24, and remove the holders 30 after the process(es) are performed on the articles.

As shown in FIG. 1, the conveyor 24 may rotate in the direction of the large arrow F in a horizontal plane about an axis A, which in this case is vertical. If the apparatus 20 is considered to be located in a Cartesian coordinate system, for purposes of this description the vertical direction will be considered to be in the direction of the Z-axis. In FIG. 1, conveyor 24 is oriented in the X-Y plane, and the direction of rotation F is counter-clockwise. In other embodiments, the direction of rotation may be counter-clockwise. The conveyor 24 may rotate at a constant velocity, or the velocity of rotation may be varied, if desired. The rotation of the conveyor 24 may be continuous, or if desired, intermittent. The article(s) 10 will have a vector, V, representing the direction of movement (that is, the conveying direction) of (and velocity of) the article 10 at any given place along the path P which the article(s) 10 are conveyed.

The apparatus 20 and method deposit a substance 22 on the surface of the article(s) 10. The apparatus 20 and method are particularly useful for printing directly on and/or decorating the surface of the article(s) 10. For instance, instead of attaching a pre-printed label to an article such as a bottle, the apparatus and method can be used to directly print the subject matter of the label on the article. Of course, the apparatus and method are not limited to printing subject matter which serves as a label on the articles. The apparatus and method are also useful in decorating the articles such as by printing designs, or providing a visual, tactile, or olfactory effect on articles by means of a material deposition on the articles 10.

The apparatus 20 can comprise any suitable number, arrangement, and type of deposition device(s) 26. For example, the apparatus may comprise between 1-20, or more, deposition device(s) 26, alternatively between 2-10 deposition device(s) 26. Thus, there may be a plurality of deposition devices 26. The deposition device(s) 26 may be joined to, or located on, the conveyor 24. Alternatively, the deposition device(s) 26 may be located adjacent to the conveyor 24. When the deposition device(s) is described herein as being located “adjacent” to the conveyor 24, there may be a separation between the device 26 and the conveyor 24 (and the articles 10). However, the separation between the deposition device 26 and the intended deposition surface 12 of the article 10 should not exceed the effective deposition distance of the deposition device 26 for depositing the substance in the desired predetermined pattern. For example, if the deposition device 26 is an ink jet print head, and the deposition range of the ink jet print head is between about 0.5-10 mm, then the deposition device 26 should be located sufficiently close, or adjacent, to the conveyor 24 so that the intended deposition surface 12 of the article 10 is within such a deposition range. The deposition device(s) 26 may be arranged in a spaced apart relationship along the article conveyor 24. Alternatively, one or more of the deposition device(s) 26 may be positioned adjacent to and in contact with another one of the deposition device(s) 26.

The deposition device(s) 26 may be positioned inside or, as shown in FIG. 1, outside of the path of movement P of the articles 10. In embodiments in which the deposition device(s) 26 lie flat on the conveyor, the deposition device(s) 26 may be positioned above the articles 10 on the article conveyor 24. The deposition device 26 can be stationary or fixed relative to the ground; or, it can be movable (as described below). If the deposition device 26 is movable, it may have its movement limited to a particular direction and a particular amount.

The substance deposition device(s) (“deposition device(s)”) 26 can deposit any suitable substance (or “material”) on the article 10. The deposition devices can either be of a type that contacts the article directly or by indirectly applying pressure to the article through the material (“contacting”), or of a type that does not contact the article 10 (“non-contacting”). For the purposes of this disclosure, spraying ink on an article is considered to be non-contacting. The deposition device 26 can be any suitable type of device including, but not limited to print heads, nozzles, and other types of material deposition devices. In the case of print heads, any suitable type of print heads can be used including, but not limited to piezo inkjet print heads, thermal inkjet print heads, electrostatic print heads and/or printing valve print heads. The print heads may be a drop-on-demand type of deposition device. By “drop-on-demand”, it is meant that the print heads create droplets of ink at the nozzle only when needed such as to form a pattern in the form of words, figures (e.g., pictures), or designs. The print heads may also be “continuous” meaning drops are continuously formed at the nozzles, however only desired drops leave the print head to form the intended pattern. Ink jet print heads are typically digitally actuatable and can print images provided by a computer.

Suitable substances or materials include, but are not limited to: inks (including UV-curable inks, water-based inks, and solvent-based inks), coatings, and lotions. The material can be deposited in any suitable form. Suitable forms include, but are not limited to: liquids, powders, and hot melts (the latter being solids that may be heated to flow). The material can be deposited in any suitable pattern. Suitable patterns can be regular, irregular, or random, and include, but are not limited to: designs, images, text, an indicium, a texture, a functional coating, and combinations thereof.

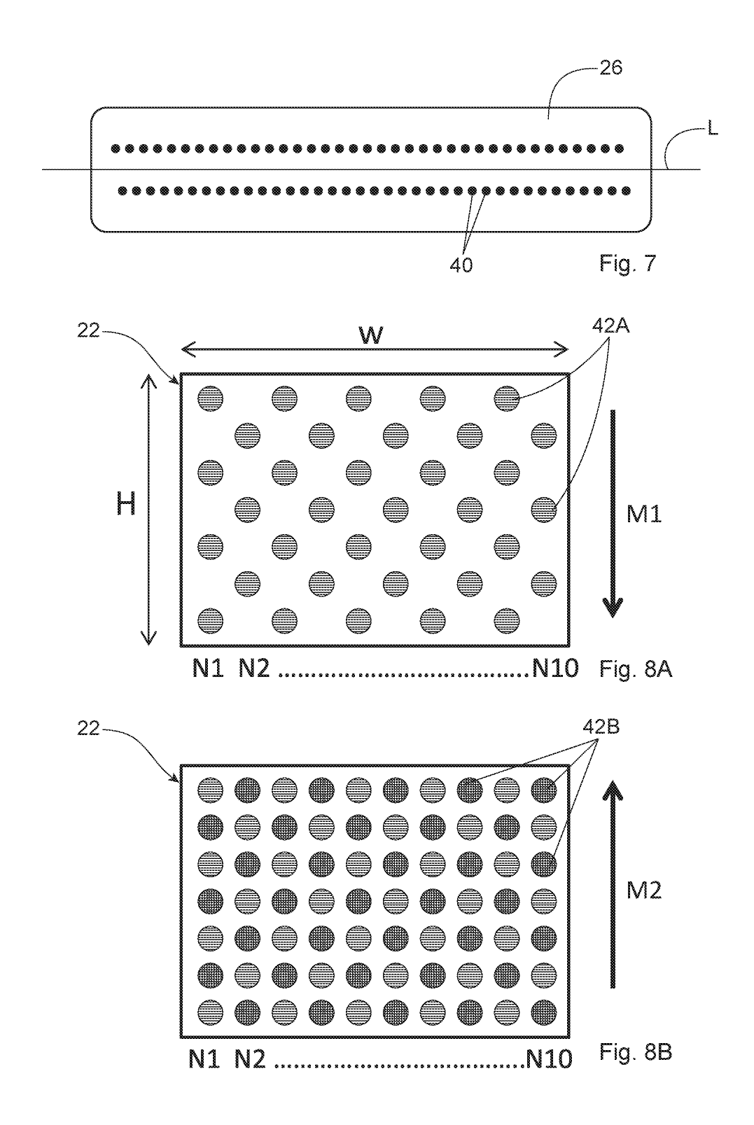

Ink jet print heads will typically comprise multiple nozzles 40. As shown in FIG. 7, the print head has a length with a linear axis L. The nozzles 40 are typically generally aligned in rows and are configured to jet ink in a particular direction that is generally parallel to that of the other nozzles. The nozzles 40 within each row on a print head 26 can be aligned linearly. Alternatively, the nozzles 40 may be in one or more rows that are oriented diagonally relative to the longer dimension (or length) of the print head. Both such arrangements of nozzles can be considered to be aligned substantially linearly. The inkjet print heads can comprise any suitable number and arrangement of nozzles therein. One suitable inkjet print head contains approximately 360 nozzles per inch (per 2.54 cm). The Xaar 1002 is an example of a suitable print head for use herein, and is available from Xaar of Cambridge, UK.

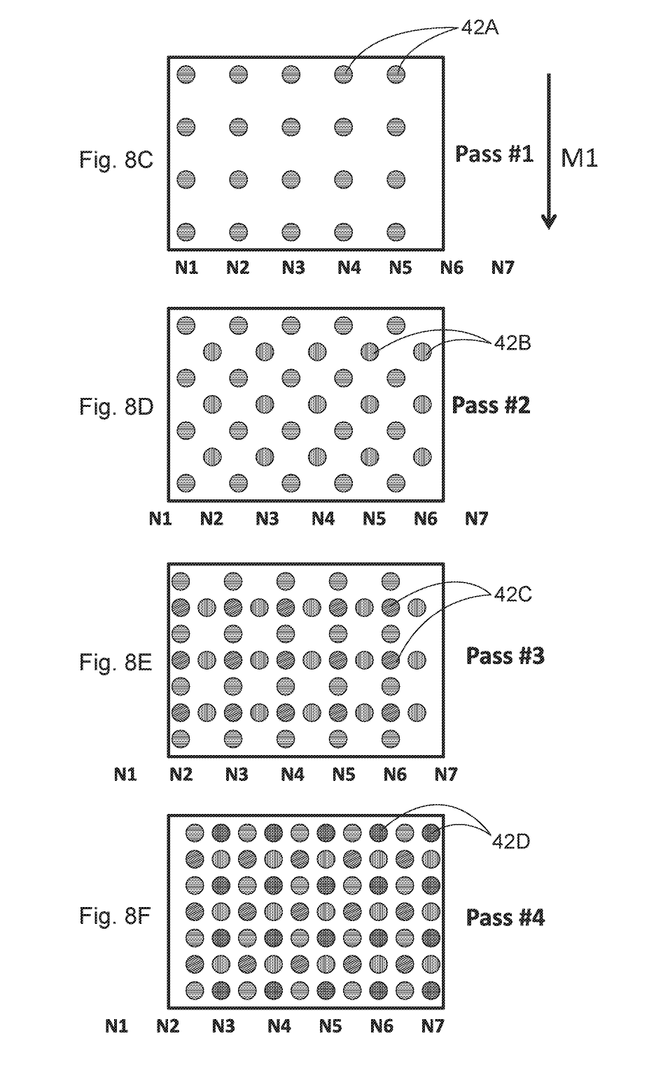

The droplets of ink formed by an ink jet print head can range in diameter from about 10 microns or less to about 200 microns, or more. The droplets of ink can be distributed in any suitable number over a given area. Typically, in ink jet printing, the ink droplets form an array or matrix in which the number of drops per inch (DPI) is specified in the direction of movement of the print head or article to be printed, and in a direction on the surface of the article perpendicular thereto. A two dimensional representation of such a matrix, or array, of ink droplets 42 is shown in FIGS. 8A and 8B. (It will be appreciated that in the process described herein, such an array or matrix may be deposited on an at least a partially three-dimensional (e.g., curved, including in a convex or concave form) surface.) The application of ink drops provided on the surface of the article to form a digital image can range from about 200, or less up to about 2,880 or more drops per inch (DPI) in at least one direction. In some cases, the droplets of ink can be deposited in a matrix that ranges from 700 to 1,440 drops per inch in at least one direction. In some cases, the droplets of ink may be deposited in a matrix that is greater than 1,200 drops per inch in at least one direction.

When the deposition device(s) 26 comprise print heads, one or more of the deposition devices 26 may comprise a printing unit (or “printing station”). The ink jet print heads may be configured to print black or color ink, adhesives, or clear varnish. Each printing unit may comprise any suitable number of print heads, from one to four or more. For example, in some cases, the printing unit may comprise four print heads for a CMYK (cyan, magenta, yellow, and key (black)) color scheme for producing different color sets of a multicolor print. The printing unit may also comprise additional print head(s) for additional colors, e.g., white and or special colors, for a priming coat as a first printing step or for a base layer, e.g., an adhesive, and/or for applying a transparent sealing or protective coating. In some embodiments, there may be multiple printing stations, such as one or more for an optional base coat, one or more for a decoration coat, and one or more for an optional top coat.

The substance 22, such as the ink(s) may be applied directly to the article(s) 10 in a predetermined pattern. The term “predetermined pattern”, as used herein, refers to any type of printed pattern including but not limited to words, figures (e.g., pictures), indicia or designs that is determined prior to the initiation of printing. The apparatus 20 and method may, at least at one station, use at least two intra-station movements to apply different portions of a predetermined pattern of a substance to the articles.

The apparatus 20 and method may create one or more types of relative motion between the articles 10 and the substance deposition device(s) 26. The relative motion can be created in any of the following manners, by: (1) moving the article(s) 10 with respect to the deposition device 26; (2) moving the deposition device 26 relative to the article(s) 10; or by moving both the article(s) 10 and the deposition device 26 relative to each other. There may be more than one different type of relative motion between the article(s) 10 and the deposition device(s) 26. In cases in which the apparatus 20 and method create more than one different type of relative motion between the articles 10 and the deposition device 26, these will be referred to herein as a first type of relative motion, a second type of relative motion, etc.

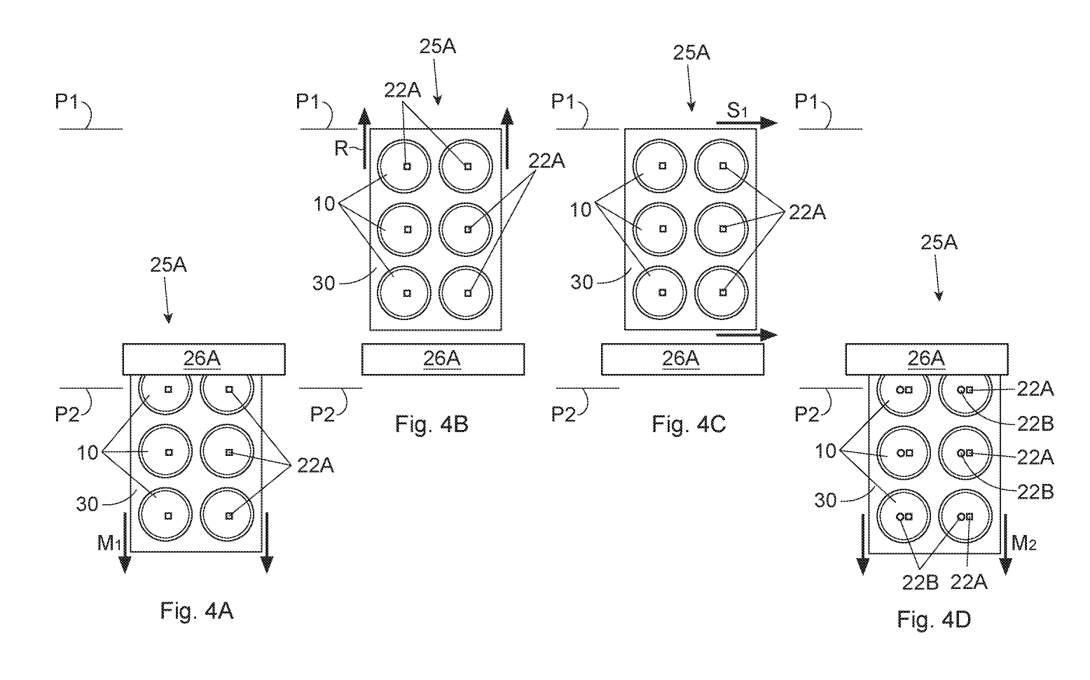

The first type of relative motion, shown by arrow F in FIG. 1 is created when the conveyor 24 conveys the articles 10 in a conveying direction. The movement of the conveyor 24 can be linear as shown in FIG. 6, non-linear as shown in FIG. 1, or partially linear and partially non-linear as shown in FIG. 5. If the conveyor 24 moves in a linear motion, there will only be one conveying direction. If the conveyor 24 moves in a non-linear motion, the conveying direction can comprise a first, a second, a third direction of movement V, . . . , etc. In some embodiments, the conveyor 24 can be in the form of a re-circulating loop. The re-circulating loop can be in any suitable configuration. The conveyor 24 may move (and, thus, move the articles 10) in a curvilinear path such as a circular path; or in a path that comprises both linear portions and curvilinear portions. Non-limiting examples of such paths include: circular paths, elliptical paths, race track configured paths (FIG. 5), and other closed loop paths. Said paths may comprise linear and non-linear conveying directions, wherein non-linear includes curvilinear, circular, elliptical, arcuate, zig-zag or other directions. During at least a portion of the re-circulating loop, the article(s) 10 are moved about an axis that is different from (e.g., offset from) the article's own axis. Thus, spinning the article about its own axis (such as spinning a container about its own axis on a mandrel), would not be considered to be conveying the article in a “re-circulating loop”.

In the embodiment shown in FIG. 1, the articles 10 are moved along an arcuate path relative to the deposition devices 26. More specifically, the conveyor 24 shown in FIG. 1 is powered by a motor (conventional and not shown) and moves the articles 10 in a circular path P in a “turret” type rotating device about axis of rotation A. The axis of rotation A may be oriented in any suitable orientation, including in a vertical orientation as shown in FIG. 1 (so that the conveyor rotates like a carrousel), a horizontal orientation (so that the conveyor rotates like a Ferris wheel), or some orientation between horizontal and vertical.

As shown in FIG. 1, in cases in which the articles 10 are moved in an at least partially non-linear motion, the normal planes P_{N} of the deposition devices 26 such as print heads will not be parallel with respect to one another when they are at least at certain places on the conveyor 24. However, the normal planes P_{N} of the print heads on a turret conveyor will be parallel with each other when at opposite sides of the turret (e.g., 12 o'clock and 6 o'clock). In certain embodiments, the relative position between a group of articles at one station 25 and at other stations will remain the same throughout the entire process to enable the precise registration of a substance applied to the articles 10 at one station with the substance applied to (or function performed on) the articles at other stations.

In addition to the first type of relative motion F, while at least at the first station 25A, the article 10 and/or the first substance deposition device 26 moves in a first of at least two intra-station movements wherein the first deposition device, such as print head(s) 26 deposits only a portion of the predetermined pattern on the surface of article(s) 10. While still at the first station 25A, the article and/or the first substance deposition device 26A is moved in a second of at least two intra-station movements wherein the first substance deposition device 26A deposits a second application of the first substance on the article 10 to form another portion of the predetermined pattern to be formed. The term “wherein”, as used herein with reference to the deposition of a substance includes, but is not limited to depositing a substance while (or during) the first and second intra-station movements). It should be understood that when the at least two intra-station movements are described herein as taking place at least at the first station, similar multiple intra-station movements may take place at the second, third, or any of the other stations along the conveyor 24.

The term “at least two intra-station movements”, as used herein, refers to movements in which a first movement takes place at a station 25 which deposits a substance 22 in a first array (that is, a “first pass”) to form a first portion of a predetermined pattern, and a second movement takes place at the same station which passes over at least a portion of the predetermined pattern deposited in the first movement, and while passing over the same (in a “second pass”), deposits a substance 22 on the surface of the article 10 within the first array to form a second portion of the predetermined pattern. There can be any suitable number of intra-station movements in which substances are deposited within the first array to form other portions of the predetermined pattern. It should be understood that the first intra-station movement may, but need not be the very first movement between the articles and the deposition device 26 that takes place at the first station. Likewise, the second intra-station movement may, but need not be the second movement between the articles and the deposition device 26 that takes place at the first station. It is only necessary that there be at least two intra-station movements wherein the ink droplets deposited in a subsequent pass (a “second intra-station movement”) at least partially overlap or fall within the matrix of ink droplets deposited in a previous pass (a “first intra-station movement”).

The intra-station movements can be in the same or different directions. Thus, in some cases, the intra-station movements may be referred to as “intra-station directional movements”. If the movements are in different directions, in some cases, they can be in opposite directions. Therefore, in accordance with the definition herein, movement of the first deposition device in a single direction (e.g., linearly) from point A to point C in either a continuous or an intermittent fashion in the course of completing a single printing “pass” would not be considered to comprise at least two intra-station movements (even though the deposition device moved through point B located between points A and C). Such a movement would only be considered to be a single intra-station movement.

Any suitable mechanism(s) or motion device 38 can be used to move the articles 10 (or holder with the articles therein) or the deposition device 26 in the two intra-station movements. In some embodiments, a single motion device 38 can be used for both intra-station movements. In other embodiments, a separate motion device 38 can be used for each intra-station movement. Suitable motion devices 38 include, but are not limited to linear motors, rotary motors, hydraulic slides and pneumatic slides. In some cases, the holder 30 may be joined to a motion device 38, and the motion device 38 may be joined to the conveyor 24. This configuration allows the articles 10 to be moved relative to the conveyor 24. In some cases the deposition device 26 will be statically mounted adjacent to the conveyor 24, therefore the motion device 38 can enable relative motion between the articles 10 and the deposition device 26. The deposition of the substance 22 on the article 10 will typically occur during the intra-station movements.

The portion of the predetermined pattern may take several possible forms. The predetermined pattern will typically cover a given area of the article. Any suitable portion of the pre-determined pattern can be printed during each intra-station movement in any suitable number of intra-station movements to form the complete pre-determined pattern.

For example, in some embodiments, as shown in FIGS. 8A and 8B, the deposition device(s) 26 may be programmed to deposit a plurality of spaced apart ink droplets 42A that form a portion of the predetermined pattern during a first intra-station movement M₁, and then on the second intra-station movement M₂, and any subsequent intra-station movements, the deposition device(s) 26 can fill ink droplets 42B in between the droplets 42A deposited on the first intra-station movement M₁.

As shown in FIGS. 8A and 8B, the ink droplets 42A and 42B are each deposited in an array. The array has a height H and a width W. FIGS. 8A and 8B also show the locations designated N1, N2, etc. of the nozzles 40 relative to ink droplets that are deposited in each intra-station movement. Together, the droplets of ink 42A deposited in the first intra-station movement M₁ and subsequent intra-station movement(s) make up the total predetermined pattern shown in FIG. 8B.

In another non-limiting embodiment, as shown in FIGS. 8C to 8F, the deposition device(s) 26 may be programmed to deposit a plurality of spaced apart ink droplets that form different portions of the predetermined pattern to be printed on the surface of an article in a four-step printing process. FIG. 8C shows one example of an array of pixels or droplets that may be deposited during a first intra-station movement M₁ to form a first portion of the total predetermined pattern to be printed on the surface of an article in a four-step printing process. During the second intra-station movement M₂, and any subsequent intra-station movements, the deposition device(s) 26 can fill ink droplets (or pixels) 42B in between the droplets 42A deposited on the first intra-station movement M₁. For example, FIG. 8D shows one example of an array of droplets 42B that form a second portion of the total predetermined pattern. FIG. 8E shows one example of an array of droplets 42C that form a third portion of the total predetermined pattern. FIG. 8F shows the fourth array of droplets 42D that form the remainder of the total predetermined pattern. As shown in FIGS. 8C to 8F, during each intra-station movement (or pass), the ink droplets can be deposited between the ink droplets deposited in a prior intra-station movement in any of the following locations: in the same columns (FIG. 8E); in the same rows (FIG. 8F); and between the same columns and rows (FIG. 8D).

The patterns of ink droplets which create the pixels, deposited in embodiments such as those shown in FIGS. 8A to 8F may be considered to be intermixed or interleaved. One advantage of intermixed or interleaved printing is that any defects in the printed image resulting from one or more of the nozzles 40 on a print head 26 not working will be less apparent than if the entire image is printed in a single intra-station movement with such defective nozzle(s). It should be understood that the patterns of ink droplets may, but does not need to, be fully intermixed or interleaved such that the ink droplets deposited in the second (or any subsequent passes) lie completely within the matrix of ink droplets deposited in the first pass. Therefore, it is only necessary for the ink droplets deposited in a subsequent pass to at least partially overlap or fall within the matrix of ink droplets deposited in a previous pass.

FIGS. 1A to 1C show one manner in which the at least two intra-station movements can occur to deposit the different portions of the predetermined pattern at the first station 25A. In FIGS. 1A to 1C (and several of the figures which follow) for simplicity, the holders 30 are shown as holding fewer articles than are shown in FIG. 1 (six articles versus twelve shown in FIG. 1). In FIGS. 1A to 1C, the print head 26A moves and the article(s) 10 remain stationary.

FIG. 1A shows the first of the two intra-station movements M₁. In this case, the first intra-station movement is downward (parallel to axis A in FIG. 1) from position P1 to position P2. The first substance deposition device 26A deposits a substance 22A on the articles 10 while the first substance deposition device 26A is moving downward. If the first substance deposition device 26A is an ink jet print head such as shown in FIG. 7, the nozzles 40 will deposit vertical rows of droplets of ink on the articles 10 as it moves downward.

Numerous alternatives of the first intra-station movement M₁ are possible. For example, in other cases, the first intra-station movement M₁ could be upward. In still other cases, the articles 10 can be oriented flat on the conveyor 24 and held in a plane (such as by a holder) that is oriented parallel to the plane of the conveyor instead of being in holders that are oriented perpendicular to the plane of the conveyor as in the embodiment shown in FIG. 1. In such a case, the first intra-station movement M₁ may be inward (or outward) relative to the axis A of the conveyor. In such a case, FIG. 1A would be a top view instead of a side view. (It should be understood that all of these possibilities apply to the embodiments shown in all of the other drawing figures described herein.)

There may be an optional setting (or stabilizing) step or period that occurs with respect to the deposited material 22 at some point after the initiation of the first intra-station movement M₁. Whether the optional setting step occurs depends on the type of material that is deposited on the articles 10. If the material 22 used is a water-based ink, the setting or stabilizing step or period may involve drying or removal of solvent (water) from the ink so that the viscosity of the ink will increase and the ink will at least partially solidify. The setting of the ink in the case of water-based inks can comprise a step of heating the ink to dry the same. Alternatively, the setting of the ink can involve a period of allowing the ink to dry without an active drying step. If the material 22 used is a UV-curable ink, the setting or stabilizing step will typically involve a step of at least partially curing the ink by photo polymerization by exposing the ink to UV radiation. In any case, the setting step or period will at least partially set or stabilize the material 22 deposited on the articles 10. The setting step or period may, but need not, completely set or stabilize the material 22 deposited on the articles. If the ink or other deposited material 22 is only partially set at one stage of the process, it can be more fully, or completely, set or cured at a subsequent stage.

Any suitable device 50 can be used to carry out the setting or stabilizing step. Suitable devices, depending on the material deposited, include, but are not limited to dryers and UV lamps. The device used to carry out the setting or stabilizing step can be at any location on the apparatus 20, or adjacent to the apparatus. FIG. 1A shows one non-limiting embodiment in which the device 50 is in the form of a UV lamp. The UV lamp 50 is located on the same carriage as the print head 26A. The device 50 is positioned adjacent to the print head 26A so that it follows the print head 26A in the direction of movement, and is capable of at least partially curing the UV ink immediately after the start of the first printing movement (or pass) M₁ and prior to the start of a second printing movement (or pass) M₂. In the embodiment shown in FIG. 1A, the curing of portions of the deposited material can be initiated even before the completion of the first intra-station printing movement M₁.

In other embodiments, the curing or setting step need not start immediately after the start of the material (e.g., ink) deposition. In such other embodiments, there can be any suitable delay between the deposition of ink and the start of the second printing movement (or pass) M₂. For example, the curing or setting step need not commence until after the completion of the first printing movement (or pass) M₁. The curing or setting step helps improve print quality by increasing the tendency for the ink droplets deposited in the first printing movement M₁ to remain as separate droplets, reducing the tendency for the ink droplets deposited during different printing movements to coalesce and merge together to create a fuzzier image.

FIG. 1B shows an optional offset or shift, S, that may occur between the first and second intra-station movements M₁ and M₂. The optional offset S can be used to shift the location of the print head 26A (and, thus, the nozzles 40 on the print head) so that they will print a different portion of the articles 10 than was printed during the first intra-station movement M₁. The optional shift S can take place at any time and at any location between the end of the first intra-station movement M₁ and the start of the second intra-station movement M₂. Typically, the optional shift S will be in a direction that is perpendicular to the direction of the printing motion M₁. In the embodiment shown in FIG. 1B, the optional shift S occurs at the end of the first intra-station movement M₁ when the print head 26A is in a position at the bottom of the print carriage's range of motion relative to the articles (position P2). The shift S is in a different direction than the first intra-station movement M₁, for example, it can be either to the left or to the right relative to the direction of the first intra-station movement M₁. In FIG. 1A, the shift S is to the left. The shift S direction may be perpendicular or at any angle, except 0 or 180 degrees, to the first intra-station movement M₁ direction (or a segment of the first intra-station movement M₁ direction). For example, the shift S direction may be at an angle that is within a range of angles relative to the intra-station movement M₁ direction from 1 to 179 degrees, or 181 to 359 degrees; alternatively from 30 to 150 degrees, or 210 to 330 degrees, with 90 or 270 degrees sometimes being more often desired. The optional shift S may allow the printing process to form a higher resolution image.

FIG. 1C shows the second intra-station movement M₂. During the second intra-station movement M₂, the first substance deposition device 26A deposits a second application of a substance (such as the first substance) 22B on the article 10 to form another portion of the predetermined pattern. In the embodiment shown, during the second intra-station movement M₂, the first substance deposition device 26A will deposit a substance 22B on the articles 10 while the first substance deposition device 26A is moving upward (from P2 to P1). If the first substance deposition device 26A is an ink jet print head, it will deposit vertical rows of droplets of ink 22B on the articles as it moves upward. The second intra-station movement M₂ allows the printing process to form a higher resolution image because the nozzle 40 locations on the second intra-station movement M₂ are interlaced between the nozzle locations of the first intra-station movement M₁. FIGS. 1A to 1C show that a second UV lamp 50A can be located on the same carriage as the print head 26A below the print head in order to cure the ink after the second intra-station movement M₂.

As in the case of the first intra-station movement M₁, numerous alternatives of the second intra-station movement M₂ are also possible. The second intra-station movement M₂ can, for example, be in the opposite direction to any of the possible first intra-station movements M₁ described above.

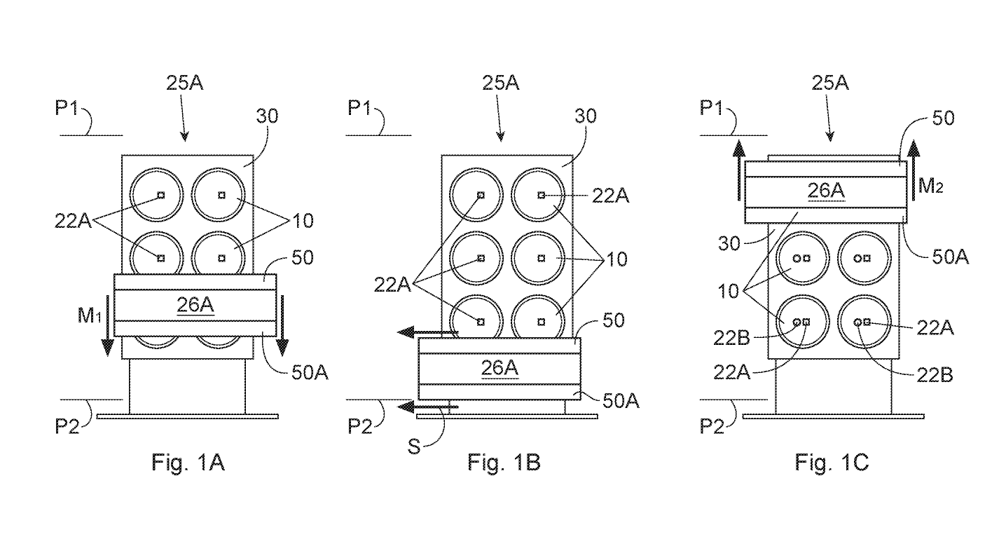

FIGS. 2A to 2D show another manner in which the at least two intra-station movements can occur at the first station 25A. FIGS. 2A to 2D (and the figures which follow) are shown without the UV lamps for simplicity. Any suitable setting or curing device could be provided in any of these embodiments. In FIGS. 2A to 2D, the first substance deposition device 26A moves and the article(s) 10 remain stationary as in the case of the embodiment shown in FIGS. 1A to 1C. The movement of the first substance deposition device 26A shown in FIG. 2A is the same as that shown in FIG. 1A. FIGS. 2B to 2D differ in that those figures show an alternative embodiment in which the deposition device such as the print head 26A may undergo a non-printing reset R back to its original position P1 (as shown in FIGS. 2B and 2C). In such a case, the second intra-station movement M₂ which deposits droplets 22B (as shown in FIG. 2D) can be in the same direction as the first intra-station movement M₁.

In embodiments such as shown in FIGS. 2A to 2D where there are both an optional shift S and a reset R, the shift and reset can occur in any manner and order. For example, the shift S can take place at the top or bottom of the upper and lower limits of the movement (P1 and P2, respectively) of the substance deposition device 26A, or at some place therebetween. The shift S and reset R may occur separately as shown in the drawings (wherein one of the shift or reset takes place before the other, and the different movements are at right angles). Alternatively, the shift and reset can take place simultaneously (wherein the substance deposition device 26A moves diagonally to its shifted and reset position).

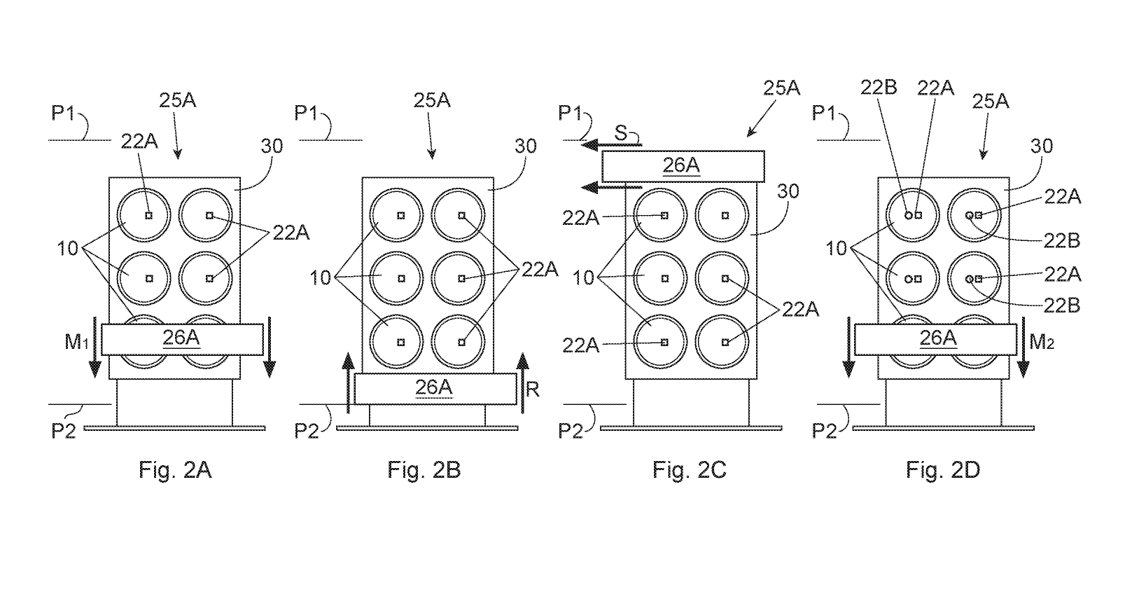

FIGS. 3A to 3C show another manner in which the at least two intra-station movements can occur at the first station 25A. In FIGS. 3A to 3C, the article(s) 10 (or holder 30 with the article(s) therein) move and the first substance deposition device 26A (print head) remains stationary. The relative movements of the articles 10 shown in FIGS. 3A and 3C are similar to the movements of the first substance deposition device 26A shown in FIGS. 1A to 1C. FIG. 3A shows the first of two intra-station movements M₁ of the articles 10, a downward movement of the articles 10 from position P1 to P2 (which positions are shown as being the limits of movement with a reference point being at the top of the holder 30). FIG. 3B shows an optional offset/shift S of the articles 10 between intra-station movements. As shown in FIG. 3B, the shift S is to the right. FIG. 3C shows the position of the articles 10 near the end of the second of two intra-station movements M₂, an upward of the articles 10 back to position P1.

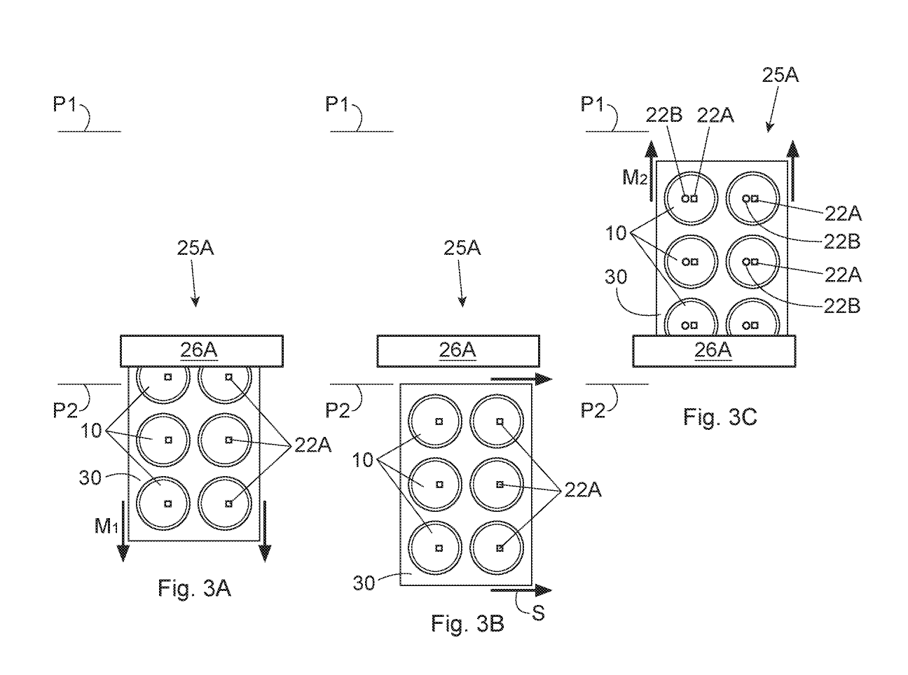

FIGS. 4A to 4D show another manner in which the at least two intra-station movements can occur at the first station 25A. In FIGS. 4A to 4D, the article(s) 10 (or holder 30 with the article(s) therein) move and the print head 26A remains stationary. The movement of the articles 10 shown in FIG. 4A is the same as that shown in FIG. 3A. FIGS. 4A to 4D differ in that FIGS. 4B to 4D show an alternative embodiment in which the articles 10 may undergo a reset R back to their original position P1 (as shown in FIG. 4B) and a shift S at their original position P1. In such a case, the second intra-station movement M₂ of the articles 10 (as shown in FIG. 4D) can be in the same direction as the first intra-station movement M₁. As in the case of the optional reset R and shift S of the print head, the reset and shift of the articles 10 can occur in any manner and order.

In addition to the optional reset R and shift S that may occur between the intra-station motions when depositing a substance 22 on an article 10, the component that undergoes motion during the intra-station movements may optionally undergo a further positional recovery where it moves back to an initial position after the last intra-station movement for one article (or group of articles) and before the first intra-station movement for the next article (or group of articles).

FIG. 5 shows an alternative embodiment of an apparatus 20 for depositing a substance on at least one article 10. In the embodiment shown in FIG. 5, the article conveyor 24 is in a race track configuration. This type of conveyor will have two parallel axes about which the conveyor 24 and the articles 10 rotate during at least a portion of the path of travel. These axes are designated A1 and A2. The apparatus 20 shown in FIG. 5 can have any of the properties described above with respect to the apparatus shown in FIG. 1 including, but not limited to its orientation (horizontal or vertical), and arrangement of the deposition device(s) 26 relative to the conveyor 24, and arrangement of any article holders 30 thereon. In such a race track embodiment, as shown in FIG. 5, it is possible to arrange the deposition device(s) 26 so that the article(s) 10 is moving either on a curvilinear path or a linear path past the deposition device(s) 26 depending on whether the deposition device(s) 26 is located at one of the ends 32 of the race track shaped path, or along one of the sides 34 of the race track shaped path. FIG. 5 also shows an optional pre-treatment device 48 and a curing device 50.

The various embodiments of the method may have certain attributes. The substance 22A applied at the first station 25A during the first intra-station movement M₁ can be the same as the substance 22B applied during subsequent intra-station movements at the first station 25A. For example, the same color ink can be printed during the at least two intra-station movements at the first station 25A. In other embodiments, the substance 22B applied during some or all of the subsequent intra-station movements at the first station 25A can differ from the substance 22A applied at the first station during the first intra-station movement M₁. In these latter embodiments, the substance 22B applied during subsequent intra-station movements at the first station 25A can differ from the substance 22A applied at the first station during the first intra-station movement M₁ in at least one compositional property including, but not limited to color, perfume, chemistry, gloss or sheen, viscosity, etc.

It will be appreciated that the apparatus 20 and method described herein allows any portion of any predetermined pattern to be applied to an article during each intra-station movement. In addition to printing any portion of the predetermined pattern of ink during each intra-station movement, the predetermined pattern could also comprise an optional base coat under the ink and/or an optional protective coat such as a clear coat disposed over the ink. In such cases, if desired, the optional base coat may be applied under all, or only a portion of the predetermined pattern of ink. Likewise, if desired, the clear coat may be applied over all, or only a portion of the predetermined pattern of ink.

The predetermined pattern of ink can either be the same for each article 10 or different for different articles. For example, the same predetermined pattern of ink can be applied to all of the articles 10 in a given holder 30, or to all of the articles 10 in all of the holders 30 on the apparatus. In other embodiments, since the printing is computer controlled, a different predetermined pattern can be applied to different articles in a given holder, or to the articles in each different holder.

The substance applied at the first station 25A can be the same as the substance applied at a second station 25B, or subsequent station. In other embodiments, the substance applied at a second, or subsequent station can differ from the substance applied at the first station 25A. In these latter embodiments, the substance applied at a second station 25B, or subsequent station can differ from the substance applied at the first station 25A in at least one compositional property including, but not limited to color, perfume, chemistry, gloss or sheen, viscosity, etc. It may be desirable to have multiple deposition devices, such as print heads, 26 that are simultaneously applying a different substance to separate groups of articles (such as in different holders) on the same conveyor. If multiple substance deposition devices are working on different groups of articles at the same time, this will provide the process with increased output.

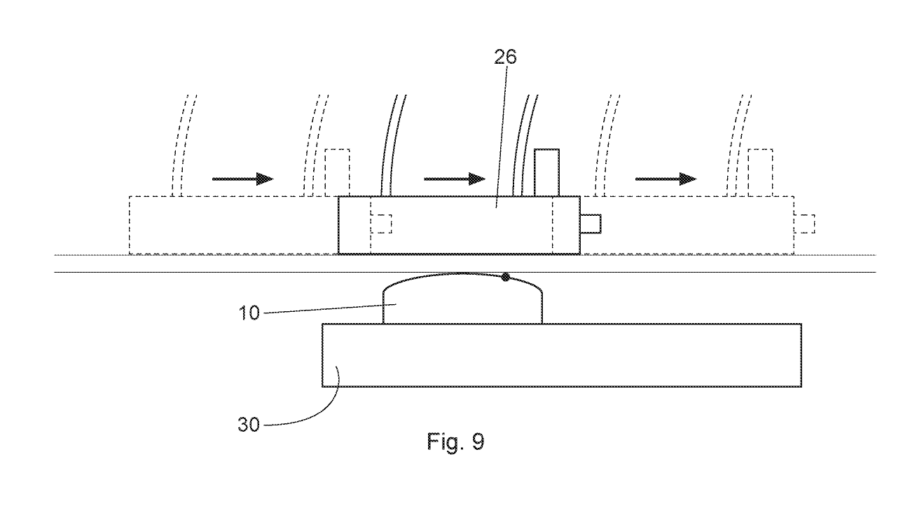

The intra-station movements shown in the various groups of figures in FIGS. 1A to 4D can take place at any of the stations on the different types of conveyors 24 shown in FIGS. 1, 5, and 6, or on any other suitable conveyor. Thus, the apparatuses and methods are not limited to the examples shown in the drawings. Regardless of the configuration of these conveyors and how the normal planes P_{N} of the deposition devices 26 are oriented, FIG. 9 shows that in each of these cases the steps of moving the article 10 and/or deposition device 26 during the intra-station movements M₁ and M₂ is such that the article(s) 10 and/or the deposition device 26 move substantially by translation (a sliding or linear motion) with respect to each other during the deposition of substance on the article(s). That is, the relative motion between articles 10 and the deposition device 26 is substantially in translation. In some cases, the relative motion between articles 10 and deposition device 26 can be solely in translation. In such cases, there will be no rotational movement of the articles 10 about their own axis relative to the deposition device 26.

Other types of relative motion are also possible. For example, in certain embodiments, it may be desired to move the article 10 in order to present a different portion of the article to the deposition device 26. In some cases, a rotational component (or secondary motion) can be added to the movement by translation (the primary movement during substance deposition). However, any rotation of the articles 10 about an article's own axis should be less than 360°, alternatively less than or equal to about 270°, alternatively less than or equal to about 180°, alternatively less than or equal to about 90°, alternatively, less than or equal to about any angle of rotation that is greater than zero and less than 90°. In other cases, the article 10 could be turned or rotated in any suitable manner between the first station 25A and subsequent station(s).

The intra-station movements M₁, M₂, etc. are believed to allow the apparatus and method to provide better print quality by allowing the ink drops to more fully form into the desired shape before another drop is placed adjacent thereto. As a result, there will be a reduced tendency for one drop that is deposited during one intra-station movement to bleed into an adjacent drop or drops deposited during another intra-station movement.

Numerous alternative embodiments and/or optional additional components of the apparatus and method are possible. If there is more than one deposition device 26, one or more deposition devices may be movable and one or more deposition devices may be stationary. If there is more than one movable deposition device such as a print head 26, the different print heads 26 may all move with the same type of movement. Alternatively, certain print heads 26 can move with one type of movement, and other print heads 26 can move with a different type of movement.

In addition, the apparatus 20 may further comprise one or more optional additional stations and devices (other than substance deposition devices) that are positioned at any desired location along the conveyor 24. The additional devices may comprise functional devices for performing a function on the articles 10 while they are at the additional stations. The functional devices may include, but are not limited to: additional substance deposition devices; devices for treating articles (e.g., devices for treating the surface of articles, or for curing substances applied to the articles); devices for decorating articles (e.g., application of a metal foil); devices for transforming a property of an article (e.g., laser); or combinations thereof.

Such additional devices may include, but are not limited to pre-treatment devices 48 for treating the surface of the articles, such as ionised air cleaning, flame treatment, corona treatment, and plasma jet treatment devices. For example, if desired, the surface of the articles 10 can be treated prior to printing.

Such additional devices may also include devices 50 for drying or curing the articles after printing or other treatment (such as ultra-violet (UV) light sources or electron beam sources). If desired, the deposited material 22 may be cured at or after any station, including at or after each station. For example, if the substance 22 is a UV-reactive ink, such an ink could be cured at or after one or more stations by exposure to UV light or an electron beam.

Such additional devices may also include devices for orientation of the articles. An example of devices for orientation of the articles is a station that comprises devices that are used to: take custody of the article(s) 10; use a vision system to identify a visual indicator at a specific location of the article(s); and comprise a device used to orient the article(s) in a specific way based of the visual indicator.

Some examples of optional or alternative stations and process steps are provided below. In one embodiment, at least a portion of the articles 10 can be provided with a structured cured varnish coating. A structured cured varnish coating may be formed by the steps of: 1) providing an article such as a container; 2) applying a layer of radiation-curable varnish to the article (which may take place at a printing station); 3) impressing a pattern into the layer of radiation-curable varnish by using a structured master film; 4) curing the varnish while the master film is impressed in the varnish layer; and 5) removing the master film. Further details on methods for providing articles with a structured cured varnish coating are described in U.S. Patent Application Publication US 2014/0131352, titled “Molded Container with a Structured Varnish Coating” (P&G Case 12616).

As discussed above, the apparatus 20 can also comprise a decoration station. The decoration station is a station at which a visual, tactile, or olfactory effect is applied by means of material deposition to an article 10 or by transforming a property of an article, or combinations thereof. An example of transforming a property of an article without depositing a material on the article is imparting an image on the surface of an article by a laser. A single decoration station can be used to apply a single decorative effect or multiple decorative effects. Alternatively, multiple decoration stations can be used to apply the decorative effect(s). The decoration may occur before or after the printing of a substance on the articles 10.

In some embodiments, the decoration station may comprise the application of a metallic substance to the articles. The metallic substance may be a foil. The foil application station may be either a hot or cold foil process. The steps can be performed in any suitable manner. In the case of a cold foil process, the cold foil application station (or stations) may perform the following steps on the article: 1) depositing, including digitally depositing, an adhesive on the article in a predetermined pattern; 2) impressing a metallic foil on the adhesive; 3) at least partially curing the adhesive; and 4) removing the foil to leave a metallic effect where the adhesive was deposited. Alternatively, the cold foil application station could perform the following steps: 1) depositing a low tack material on the article in a predetermined pattern; 2) transforming the material into a high tack pressure sensitive adhesive; 3) impressing a metallic foil on the adhesive; 4) removing the foil to leave a metallic effect where the adhesive was deposited. Transforming the material into a high tack pressure sensitive adhesive can take place in any suitable manner including, but not limited to heat activation or photo polymerization.

If desired, the foil can have a receptive coating or primer applied thereto which is over-printable by a printing process that may occur after the foil application in order to achieve the desired adhesion of the ink to the foil. In some cases, the receptive coating or primer may be a lacquer. If desired, a protective coating such as an applied lacquer can be applied after the foil is applied to protect the foil and any inks printed thereon.

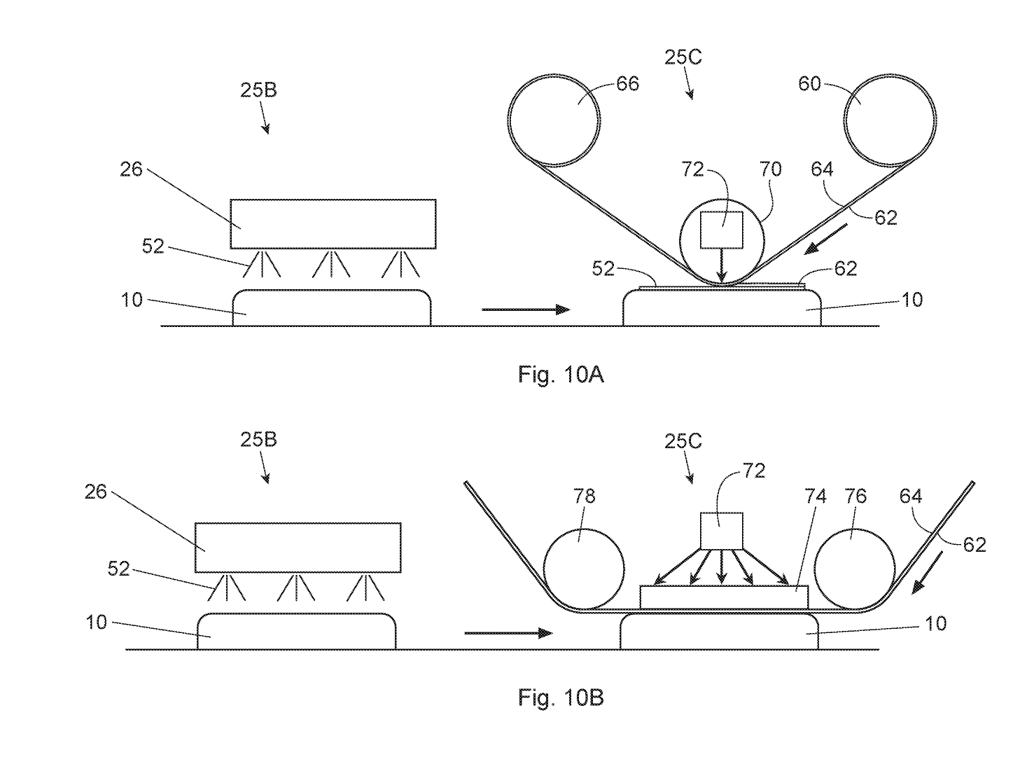

FIGS. 10A and 10B show two embodiments of a cold foil process. It should be understood that although the articles 10 are shown in FIGS. 10A and 10B as being conveyed in a linear conveying direction, such cold foil processes can be performed at any of the stations 25 of the different types of conveyors 24 described herein.

FIG. 10A shows a station 25B for carrying out the first step of depositing an adhesive 52 on the articles 10. The adhesive 52 can be of any suitable type including, but not limited to UV curable, pressure sensitive, or both. The adhesive 52 can be applied in any suitable manner. In some cases, it may be desired to deposit the adhesive 52 by a digital application process, such as by an ink jet printing process, for precise location of the adhesive. This can be done by using an ink jet print head 26 similar to those used at the first station 25A. The process of applying the adhesive 52 may be done in a single movement, or in at least two intra-station movements as in the first station 25A.

FIG. 10A also shows one embodiment of a second station 25C of a cold foil process. The equipment at the second station 25C comprises: an unwind roll 60 containing a metallic substance 62 on a backing 64; a rewind roll 66; a roll 70 for pressing the backing 64 with the metallic substance 62 thereon against the article(s) in cases in which a pressure sensitive adhesive was used; and a device 72 for at least partially curing the adhesive in cases in which a UV curable adhesive was applied to the article(s). The steps at the second station 25C comprise the steps of: 2) impressing a metallic foil onto the adhesive; 3) at least partially curing the adhesive; and 4) removing the foil and any non-transferred metal to leave a metallic effect where the adhesive was deposited.

FIG. 10B shows a similar station 25B, but with another embodiment of a second station 25C of a cold foil process to carry out steps (2) to (4). The embodiment shown in FIG. 10B differs from the embodiment shown in FIG. 10A in that a platen 74 is located between positioning rolls 76 and 78. The platen 74 is used to impress the foil 62 onto the adhesive 52 as follows: 1) the article 10 with adhesive is indexed underneath the platen 74; 2) the platen 74 moves toward the article 10 impressing the foil 62 onto the adhesive 52 on the article 10; 3) adhesion is obtained between the foil 62 and the article 10 either by curing a UV adhesive, or by nature of an adhesive that already has high tack properties; and 4) the film carrier 64 and any non-transferred metal is removed leaving a metallic effect where the adhesive 52 was applied.

After the desired predetermined image is applied to the article(s) 10, the article(s) in the group of articles may be transferred by the conveyor 24 to another conveyor or apparatus for further processing. For example, if the article(s) 10 are bottles, the bottles may be transferred from the conveyor 24 to a filler, and capper.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “90°” is intended to mean “about 90°”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for depositing a substance onto the surface an article in a predetermined pattern, the process comprising:
a) providing an apparatus for depositing a substance onto the surface of an article, said apparatus comprising:
1) a conveyor for transporting articles in a conveying direction to at least two stations, said stations comprising at least a first station and a second station; and
2) at least one substance deposition device comprising a first substance deposition device located at said first station and a second device comprising a functional device located at said second station, wherein at least at said first station, a cycle of at least two intra-station movements occur;
b) providing at least one three-dimensional article which has a surface;
c) conveying the article in said conveying direction with the conveyor so that said article is adjacent to the first substance deposition device at the first station with the surface of the article facing said first substance deposition device;
d) while at the first station, moving said article and/or said first substance deposition device in a first of at least two intra-station movements wherein said first substance deposition device deposits a first substance on the surface of the article so that said first substance is deposited in a first array to form only a portion of the predetermined pattern ; and
e) while still at the first station, moving said article and/or said first substance deposition device in a second of at least two intra-station movements wherein said first substance deposition device deposits a second application of said first substance on the surface of the article within the first array to form another portion of the predetermined pattern to be formed,
wherein the steps of moving the article and/or deposition device in steps d) and e) is such that the relative motion between the article and deposition device is substantially in translation.

2. The process of claim 1 wherein said conveyor transports said articles along a linear path between said first station and said second station.

3. The process of claim 1 wherein said conveyor transports said articles along a path between said first station and said second station, wherein at least a portion of said path is non-linear.

4. The process of claim 3 wherein said conveyor transports said articles along a path that is in the form of a closed loop.

5. The process of claim 4 wherein said closed loop path has at least one axis, and the first and second intra-station movements are parallel to said axis.

6. The process of claim 4 wherein said closed loop path has at least one axis, and the first and second intra-station movements are perpendicular to said axis.

7. The process according to claim 1 wherein steps d) and e) comprising moving said article.

8. The process according to claim 1 wherein steps d) and e) comprising moving said deposition device.

9. The process according to claim 1 wherein the direction of the first intra-station movement and the second intra-station movement are the same.

10. The process according to claim 1 wherein the first intra-station movement and the second intra-station movement are in opposite directions.

11. The process of claim 1 further comprising a step of shifting at least one of said article and deposition device at an angle to the direction of the first intra-station movement after step d) and before step e).

12. The process of claim 1 wherein the functional device located at said second station comprises a second deposition device.

13. The process of claim 1 wherein at both of the first and second stations, a cycle of at least two intra-station movements occur.

14. The process of claim 12 wherein the substance deposition devices at the at least two stations deposit a substance that varies between the two station in at least one compositional property.

15. The process of claim 1 wherein said apparatus further comprises a holder for said article that is joined to said conveyor.

16. The process of claim 1 wherein the apparatus is configured to hold a group of articles at one station and another group of articles at another station, and the relative position between a group of articles at one station and another station will remain the same while said groups of articles are being transported by said conveyor.

17. The process of claim 1 further comprising a step of decorating said article at one or more stations.

18. The process of claim 17 wherein the step of decorating said article comprises decorating with a metallic material at one or more stations for applying a cold foil to said article.

19. The process of claim 18 comprising digitally printing an adhesive on said article in order to adhere said metallic material to said article.

20. The process of claim 15 further comprising a mechanical motion device adjacent to said apparatus wherein said article(s) are loaded into said holder by said mechanical motion device.

21. The process of claim 15 wherein said holder is removably joined to said conveyor wherein said holder can be removed from said conveyor and have at least one article inserted into said holder, and wherein the holder can then be joined to said conveyor until such time as it is desired to remove the holder from the conveyor to receive one or more additional articles.

22. The process of claim 1 wherein said apparatus comprises a plurality of substance deposition devices located at spaced apart stations on the conveyor.

23. The process of claim 22 wherein said substance deposition devices located at spaced apart stations on the conveyor each print a substance with different compositional properties on the article.
